(19) United States
(12) Patent Application Publication
(10) Pub. No.: US 2018/0238031 A1
(43) Pub. Date: Aug. 23, 2018

(54) DUAL SIZE VALVE BASE

(71) Applicant: B&R Plastics, Inc., Denver, CO (US)

(72) Inventors: Darrell A. Kulzer, Denver, CO (US); Martin L. Rohm, Aurora, CO (US)

(21) Appl. No.: 15/902,186

(22) Filed: Feb. 22, 2018

Related U.S. Application Data
(60) Provisional application No. 62/461,893, filed on Feb. 22, 2017.

(51) Int. Cl. E03B 7/09; F16K 27/12

(52) U.S. Cl. CPC E03B 7/095; F16K 27/12

(57) ABSTRACT

Disclosed is a dual size valve base that provides a fitted surface having indentations, protrusions and/or shaped surfaces that align with the lower surface of two different size valves, so that the valves fit within the valve base and do not rotate or otherwise move when secured to the valve base. The valve base has a sufficiently large platform to maintain a valve in a secure position underground on a support surface, so that the valve remains aligned with access pipes and access ports.

### BACKGROUND OF THE INVENTION

Distribution of liquids and gasses to homes and to commercial and industrial buildings is ubiquitous. For example, water is supplied through pipes underground to most buildings. Shutoff valves are normally located outside of these buildings, either on the grounds of the building or in the street. Elongated tools are used to access the valves through access ports and access pipes. In some locations, the pipes and valves may be buried 8-10 feet under surface of the ground. By burying water pipes deep in the ground, freezing can be prevented. Burying of gas pipes reduces accidental uncovering and rupture of these pipes.

### SUMMARY OF THE INVENTION

An embodiment of the present invention may therefore comprise a method of mounting different size valves on a valve base that limits rotation of the different size valves comprising: using the valve base to mount first size valves on a preselected portion of the valve base in a first direction so that first shaped surfaces of the preselected portion of the valve base match shaped surfaces on the first size valves; securing the first size valves to the predetermined portion of the valve base in the first direction so that the first shaped surfaces of the preselected portion of the valve base engage the shaped surfaces of the first size valves and limit rotation of the first size valves in the valve base; using the valve base to mount second size valves on the preselected portion of the valve base in a second direction so that second shaped surfaces of the preselected portion of the valve base are aligned with shaped surfaces of the second size valves; securing the second size valves to the predetermined portion of the valve base in the second direction so that the second shaped surfaces of the preselected portion of the valve base engage the shaped surfaces of second size valves and limit rotation of the second size valves in the valve base; placing the valve base on a support surface below ground level, the valve base engaging the support surface and substantially preventing movement of the first valves and second valves.

An embodiment of the present invention may further comprise a valve base for mounting different size valves comprising: a preselected portion on an upper surface of the valve base that has valve base shaped surfaces that match shaped surfaces of a first valve when the first valve is placed in the preselected portion on the upper surface of the valve base in a first direction, and that match shaped surfaces of a second valve when the second valve is placed in the preselected portion on the upper surface of the valve base in a second direction; first pipe slots aligned with the preselected portion in the first direction that engage first pipes connected to the first valve; second pipe slots aligned with the preselected portion in the second direction that engage second pipes connected to the second valve; a lower surface of the valve base that engages a support surface that is located below ground level so that the first valve and the second valve are held on the valve base in a manner that substantially prevents movement of the first valve and the second valve.

### BRIEF DESCRIPTION OF THE DRAWINGS

FIG. 1 is an isometric view of an embodiment of the dual size valve base.

FIG. 2 is an isometric exploded view of the embodiment of the dual size valve base of FIG. 1 together with a small valve and small connecting pipes.

FIG. 3 is an isometric exploded view of the embodiment of the dual size valve base of FIG. 1 together with a large valve and large pipes.

FIG. 4 is an isometric view showing a small valve 132 disposed in the embodiment of the dual size valve base of FIG. 1.

FIG. 5 is an isometric view of a large valve 142 disposed in the embodiment of the dual size valve base of FIG. 1.

FIG. 6 is an isometric view of a small valve disposed on the embodiment of the dual size valve base of FIG. 1 that is buried in the earth.

FIG. 7 is an isometric view of a large valve disposed in the embodiment of the dual size valve base of FIG. 1 that is buried in the ground.

FIG. 8 is a top view of the embodiment of the dual size valve base of FIG. 1.

FIG. 9 is a bottom view of an embodiment of the dual size valve base of FIG. 1.

### DETAILED DESCRIPTION OF THE EMBODIMENTS

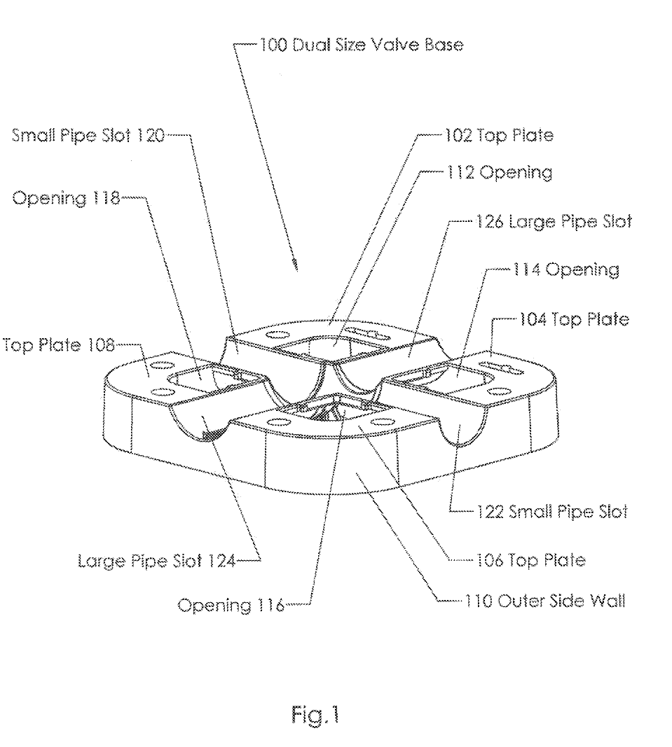

FIG. 1 is an isometric view of an embodiment of a dual size valve base 100. As illustrated in FIG. 1, the dual size valve base 100 has an outer sidewall 110 that forms a periphery of the dual size valve base 100. A series of top plates 102, 104, 106, 108 adjoin the sidewall 110 to form a series of surfaces that are aligned in a single plane. Disposed between the top plates 102, 104, 106, 108, are large pipe slots 124, 126 and small pipe slots 120, 122. The dual size valve base 100 is constructed to take two different size valves. Openings (unnumbered) in the top plates 102-108 provide drainage for water that may accumulate on said top plates 102-108. For example, a large one inch valve can be used, which sits in the center portion of the dual size valve base 100 and is aligned with large pipe slots 124, 126. A smaller three-quarter inch valve can be used, that sits in the center portion of the dual size valve base 100, that is aligned with small pipe slot 120 and small pipe slot 122. Openings 112, 114, 116, 118 are formed in top plates 102, 104, 106, 108 respectively. These openings 112-118 are aligned to allow holders such as zip ties, screw clamps, etc. to be used to hold either a small valve or a large valve in the center portion of the dual size valve base 100.

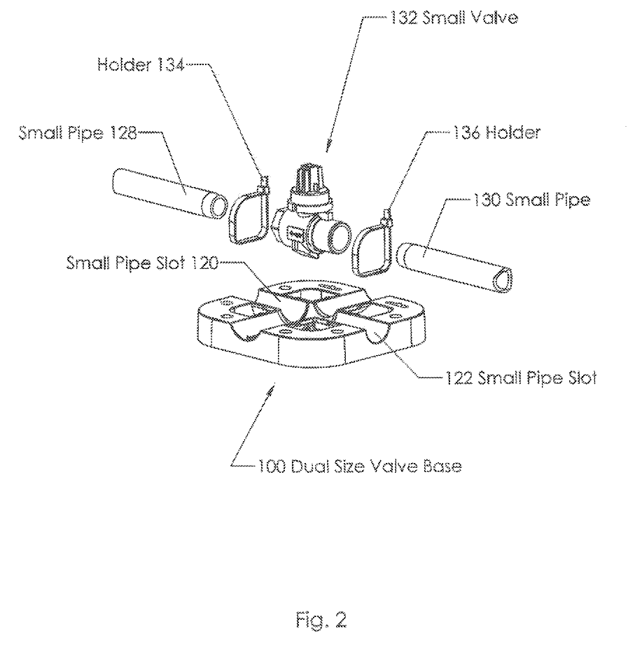

FIG. 2 is an isometric exploded view of the dual size valve base 100 together with a small valve 132, holders 134, 136 and small pipes 128, 130. As can be readily seen, small pipe 128 is aligned with the small pipe slot 120, while small pipe 130 is aligned with the small pipe slot 122, when the small valve 132 is placed in the central portion of the dual size valve base 100.

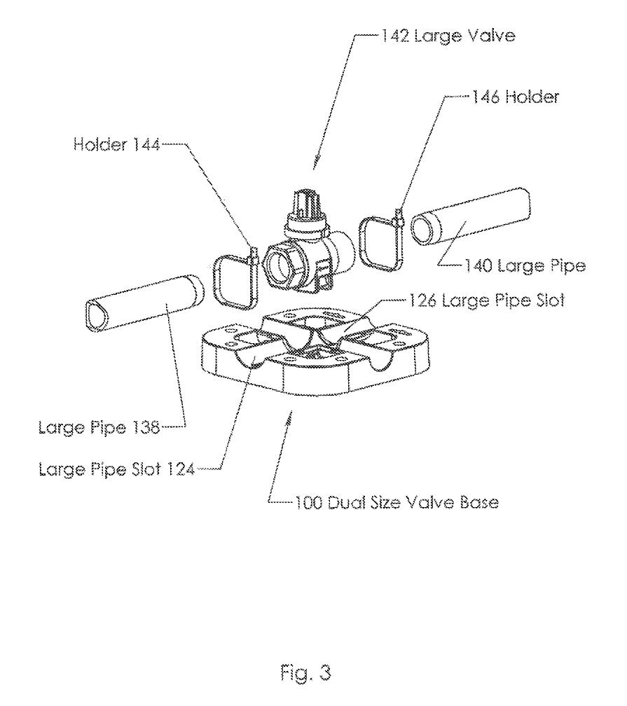

Similarly, FIG. 3 is an exploded view showing the dual size valve base 100 and the large valve 142, together with the large pipe 138 and large pipe 140. As shown in FIG. 3, the large pipes 138, 140 connect to, and are held in place by, the large valve 142, which is, in turn, held in place by holders 144, 146 respectively. The large valve 142 is adapted to sit in the central portion of the dual size valve base 100. The large pipe 138 is aligned with the large pipe slot 124 and the large pipe 140 is aligned with the large pipe slot 126. Holder 144 attaches the large valve 142 to the dual size valve base 100. Holder 146 attaches the large valve 142 to the dual size valve base 100.

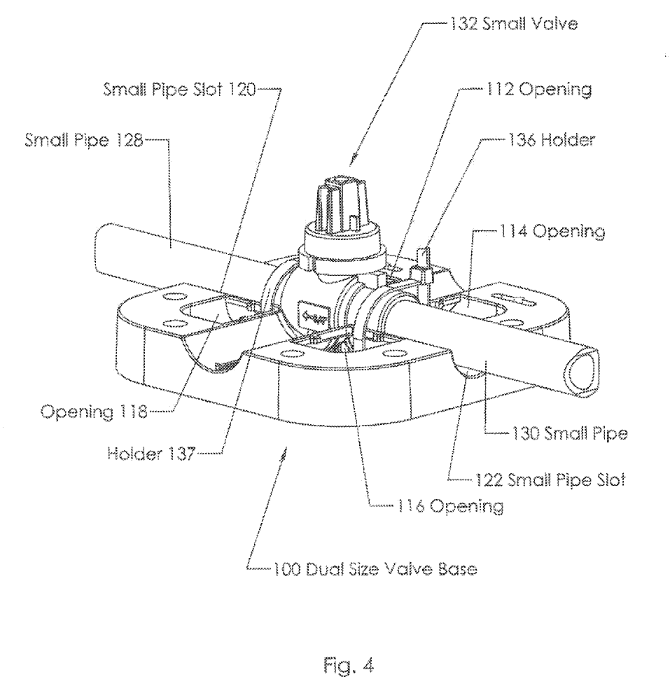

FIG. 4 is an isometric view of the small valve 132 disposed in the center portion in the dual size valve base 100. The bottom and lower side surfaces of the small valve 132 fit within various detents, shapes, protrusions, and indentations (collectively referred to as shaped surfaces) of the dual size valve base 100 to hold the small valve 132 securely in an upright position in the dual size valve base 100. The shaped surfaces of the dual size valve base 100 match the shapes and surfaces of the small valve 132 when the small valve 132 is disposed in the dual size valve base 100 in the orientation shown in FIG. 4. The small valve 132 fits into the shaped surfaces of the dual size valve base 100, which firmly positions the small valve 132 and substantially reduces, eliminates or prevents the small valve 132 from rotating or otherwise moving in the dual size valve base 100. Additionally, small pipe 128 is connected to, and held in place by, the small valve 132, while small pipe 130 is secured and held in place by the small valve 132. Holders 136, 137 secure the small valve 132 to the dual size valve base 100. Holders 136, 137 are shown as zip ties, but may comprise any device including screw clamps, spring clamps or other similar devices. Small pipe 128 sits within the small pipe slot 120, while small pipe 130 sits within the small pipe slot 122. The small pipe slots 120, 122 allow the small valve 132 to sit and engage the shaped surfaces that cause the small valve 132 to be firmly positioned within the dual size valve base 100. Opening 112 and opening 118 provide access for the holder 137 to engage the dual size valve base 100. Similarly, openings 114, 116 provide access for the holder 136 to hold the small valve 132 securely in and downwardly disposed in the central opening of the dual size valve base 100 so that the shaped surfaces of the dual size valve base 100 engage and firmly hold the small valve 132.

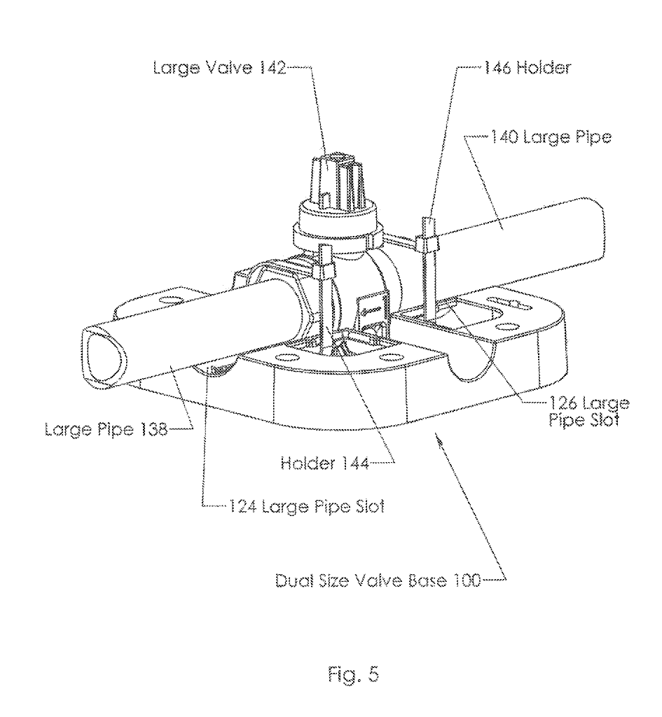

FIG. 5 is an isometric view of the large valve 142 disposed in the dual size valve base 100. Holders 144, 146 hold the large valve 142 on the center portion of the dual size valve base 100 so that the shaped surfaces of the central portion of the dual size valve base 100 engage the protrusions and shapes of the large valve 142. These shaped surfaces secure the large valve 142 so that the large valve 142 will not rotate or otherwise move in the center portion of the dual size valve base 100. Large pipe 138 is disposed in the large pipe slot 124 of the dual size valve base. Similarly, large pipe 140 is disposed in the large pipe slot 126. The large pipe slots 124, 126 allow the large valve 142 to rest in the central portion of the dual size valve base 100, and allow the lower surfaces of the large valve 142 to engage the various detents and shapes of the dual size valve base 100 that prevent the large valve 142 from moving or rotating with respect to the dual size valve base 100.

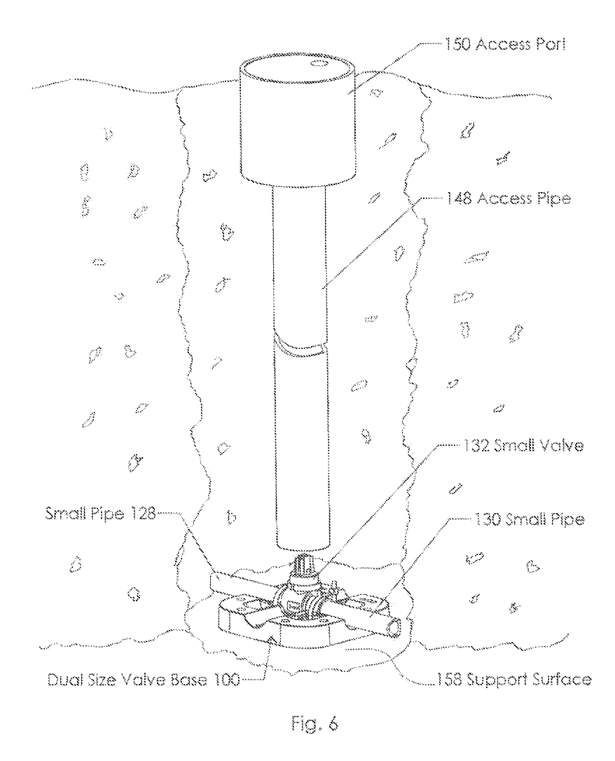

FIG. 6 is an isometric view of the dual size valve base 100 and small valve 132 disposed underground. The dual size valve base 100 is positioned or mounted on the support surface 158 below the ground surface. The small pipes 128, 130 extend through the ground. For example, small pipe 130 may be connected to an underground water main while the small pipe 128 is connected into a building. The support surface 158 is, preferably, prepared and compacted to provide an adequate support for the dual size valve base 100 so that the dual size valve base 100 remains in a substantially stationary position and does not move or rotate in any fashion. Without a valve base such as dual valve base 100, the small valve 132 may rotate on the small pipes 128, 130 so that the small valve 132 is not aligned vertically with the access pipe 148 and the access port 150. When that occurs, a tool inserted in the access port 150 and through the access pipe 148, will not be able to engage the small valve 132 to operate the small valve 132, such as by rotating a valve actuator on small valve 132. As such, the shaped surfaces in the dual size valve base 100 engage the lower surfaces of the small valve 132 and prevent the small valve 132 from rotating, or otherwise moving in the dual size valve base 100.

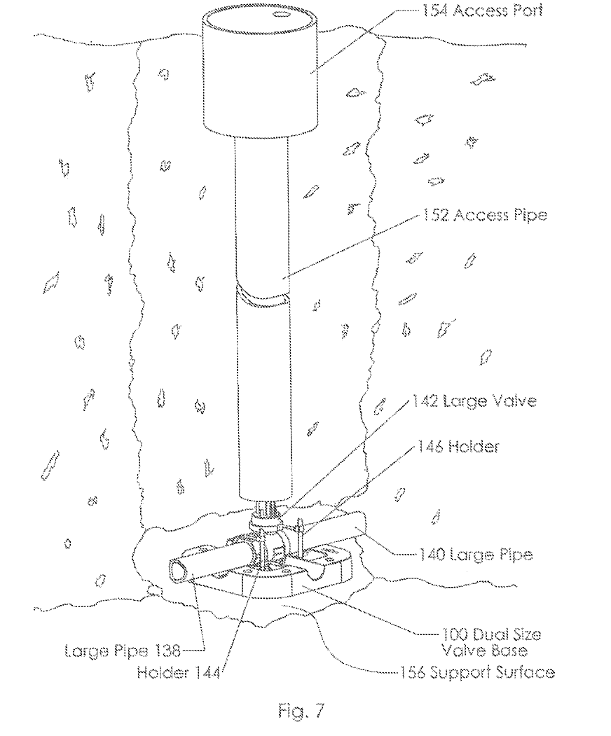

FIG. 7 is an isometric diagram of a dual size valve base 100 with a large valve 142 and large pipes 138, 140 disposed in the dual size valve base 100. Large pipe 138 may be connected to a building while a large pipe 140 may be connected to a water main. The dual size valve base 100 is disposed on a support surface 156 that holds the dual size valve base 100 in a secure and steady position so that the dual size valve base 100 does not move or rotate. Again, the dual size valve base 100 has detents and shaped surfaces that match the lower surfaces of the large valve 142 so that the large valve 142 does not rotate in the dual size valve base 100. Holders 144, 146 hold the large valve 142 securely on the central portion of the dual size valve base 100 so that the lower surfaces of the large valve 142 are held securely on, and engage, the shaped surfaces of the central portion of the dual size valve base 100. By securing the large valve 142 to the dual size valve base 100, rotation of the large valve 142 is substantially prevented. Access pipe 152 and access port 154 are aligned with the top portion of the large valve 142 so that a tool can be inserted through the access port 154, and through the access pipe 152, to access and operate large valve 142, such as by rotating a valve actuator of large valve 142, which will either open or close the large valve 142.

Of course, the central portion of the dual size valve base 100 has detents, protrusions, and shapes that match both the large valve 142, which is placed in a first direction as shown in FIG. 7 and a small valve 132, which is placed in a different direction, as shown in FIG. 6, in the dual size valve base 100. As such, the dual size valve base 100 can be used with either a large valve 142 or a small valve 132 and used equally as well with either the large valve 142 or small valve 132 since the shaped surfaces in the center portion of the dual size valve base 100 fit both the large valve 142 and small valve 132 when the large valve 142 and small valve 132 are aligned in the proper direction on the dual size valve base 100. Access pipe 152 and access port 154 are aligned with the top portion of the large valve 142, so that an elongated tool can be inserted through the access port 154 and through the access port 152 to allow the large valve 142 to be operated, such as by rotating a valve actuator, which will either open or close the large valve 142.

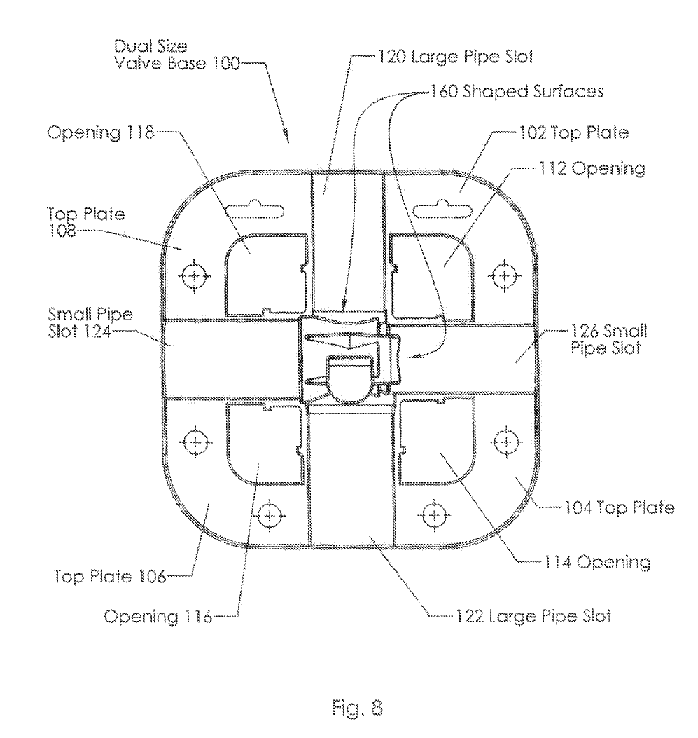

FIG. 8 is a top view of the dual size valve base 100. As shown in FIG. 8, the dual size valve base 100 has top plates 102, 104, 106, 108. Openings 112, 114, 116, 118 are formed in the top plates 102, 104, 106, 108, respectively. Openings 112-118 provide access to allow the holders to secure the valves to the dual size valve base 100. A large pipe slot 120, which comprises a depressed, curved portion, is located between the top plates 102, 108. Similarly, large pipe slot 122 is a depressed, curved section that is disposed between top plate 104 and top plate 106. Small pipe slot 124 is located between top plate 106 and top plate 108, while small pipe slot 126 is located between top plate 102 and top plate 104. Each of these pipe slots intersects in a central portion of the dual size valve base 100. The central portion of the dual size valve base 100 has various shaped surfaces 160 that match the lower surfaces of the large valve 142 and small valve 132, so that the shapes and protrusions of the large valve 142 and small valve 132 fit in the shaped surfaces 160, and rest in these shaped surfaces 160, in a stable and secure manner. When the large valve 142 and small valve 132 are anchored by the holders, which are wrapped through the openings 112, 114, 116, 118, the large valve 142 and small valve 132 are firmly secured on the dual size valve base 100. Both the large valve 142 and the small valve 132 must be placed in the proper direction, so that there is a match between the lower surfaces of the large valve 142 and small valve 132 and the shaped surfaces 160. The shaped surfaces 160 substantially prevent the large valve 142 and small valve 132 from rotating or otherwise moving in the dual size valve base 100. Very slight movement may exist even though the valves are disposed and secured to the dual size valve base 100. However, any amount of significant rotation would result in the breaking of the holders, or breaking of the shaped surfaces 160 of the dual size valve base 100. As such, there is no substantial rotation of movement of the valves in the holder.

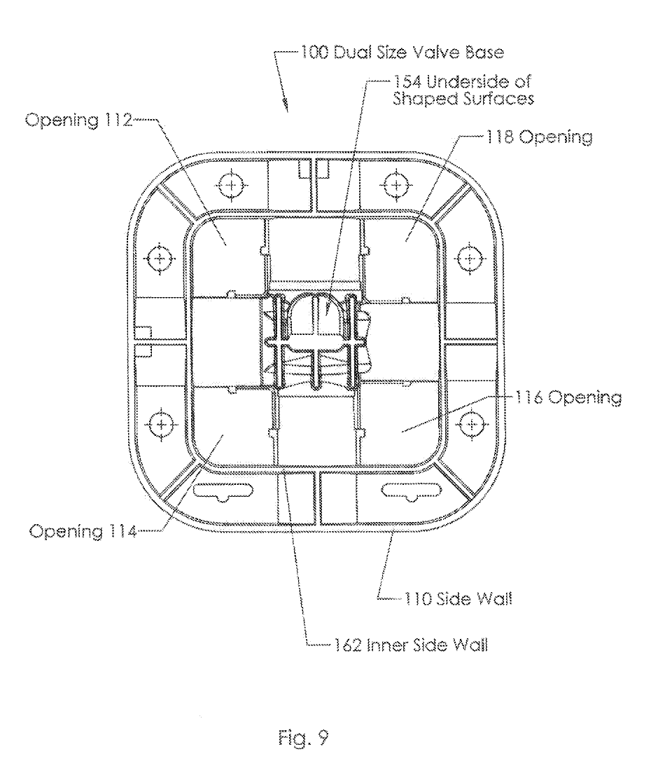

FIG. 9 is a bottom view of the dual size valve base 100. As illustrated in FIG. 9, there are four openings 112, 114, 116, 118. Outer sidewall 110 comprises one of the structural elements of the dual size valve base 100. Inner sidewall 162 comprises an additional structural element of the dual size valve base 100. FIG. 9 also illustrates the underside 154 of the shaped surfaces 160.

The embodiments of the present invention therefore provide a unique structure for holding two different size valves on a base structure so that the valves do not substantially move or rotate. As a result, the valves remain aligned with access pipes and access ports, so that elongated tools can be used to access and operate the valves. The valve base is also sufficiently large to maintain the valve in a fixed position and provide a stable platform for locating the valve and ensuring that the valve does not move with respect to the pipes that are connected to the valve.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of mounting different size valves on a valve base that limits rotation of said different size valves comprising:
using said valve base to mount first size valves on a preselected portion of said valve base in a first direction so that first shaped surfaces of said preselected portion of said valve base match shaped surfaces on said first size valves;
securing said first size valves to said predetermined portion of said valve base in said first direction so that said first shaped surfaces of said preselected portion of said valve base engage said shaped surfaces of said first size valves and limit rotation of said first size valves in said valve base;
using said valve base to mount second size valves on said preselected portion of said valve base in a second direction so that second shaped surfaces of said preselected portion of said valve base are aligned with shaped surfaces of said second size valves;
securing said second size valves to said predetermined portion of said valve base in said second direction so that said second shaped surfaces of said preselected portion of said valve base engage said shaped surfaces of second size valves and limit rotation of said second size valves in said valve base;
placing said valve base on a support surface below ground level, said valve base engaging said support surface and substantially preventing movement of said first valves and second valves.

2. The method of claim 1 further comprising:
connecting first size pipes to said first size valves;
placing said first size pipes in first size slots in said valve base in said first direction;
connecting second size pipes to said second size valves;
placing said second size pipes in second size slots in said valve base in said second direction.

3. A valve base for mounting different size valves comprising:
a preselected portion on an upper surface of said valve base that has valve base shaped surfaces that match shaped surfaces of a first valve when said first valve is placed in said preselected portion on said upper surface of said valve base in a first direction, and that match shaped surfaces of a second valve when said second valve is placed in said preselected portion on said upper surface of said valve base in a second direction;
first pipe slots aligned with said preselected portion in said first direction that engage first pipes connected to said first valve;
second pipe slots aligned with said preselected portion in said second direction that engage second pipes connected to said second valve;
a lower surface of said valve base that engages a support surface that is located below ground level so that said first valve and said second valve are held on said valve base in a manner that substantially prevents movement of said first valve and said second valve.

4. The valve base of claim 3 further comprising:
an upper surface of said valve base having first openings formed in said upper surface for drainage.

5. The valve base of claim 3 further comprising:
second openings in said valve base adjacent to said first valve and said second valve;
holders disposed in said second openings that secure said first valve and said second valve to said valve base.
